(19) United States
(12) Patent Application Publication
(10) Pub. No.: US 2026/0131478 A1
(43) Pub. Date: May 14, 2026

(54) ROBOT, ROBOT CONTROL METHOD, AND NON-TRANSITORY RECORDING MEDIUM

(71) Applicant: CASIO COMPUTER CO., LTD., Tokyo (JP)

(72) Inventor: Tomonori SAITO, Tokyo (JP)

(73) Assignee: CASIO COMPUTER CO., LTD., Tokyo (JP)

(21) Appl. No.: 19/356,216

(22) Filed: Oct. 13, 2025

(30) Foreign Application Priority Data
Nov. 14, 2024 (JP) 2024-198950

(51) Int. Cl. B25J 11/00; B25J 9/16; B25J 13/08

(52) U.S. Cl. CPC B25J 11/001; B25J 9/161; B25J 9/1674; B25J 13/08

(57) ABSTRACT

A robot includes one or more processors to: acquire external information by a sensor; acquire an internal state of a robot body; set, as a pseudo-emotion of the robot, a third emotion, the third emotion being determined based on a first emotion or a first degree of emotional change determined based on the external information and a second emotion or a second degree of emotional change determined based on the internal state; and control operation of the robot, based on the set pseudo-emotion.

### CROSS-REFERENCE TO RELATED APPLICATIONS

This application claims the benefit of Japanese Patent Application No. 2024-198950, filed on November 14, 2024, the entire disclosure of which is incorporated by reference herein.

### FIELD OF THE INVENTION

This application relates generally to a robot, a robot control method, and a non-transitory recording medium.

### BACKGROUND OF THE INVENTION

Recent years, robots that imitate living things like pets have been developed. Among robots that imitate living things, there are robots that have a function to change pseudo-emotions, based on information input from the outside. For example, Unexamined Japanese Patent Application Publication No. 2002-233977 discloses a robot device that is configured to change pseudo appetite, based on a battery remaining amount.

### SUMMARY OF THE INVENTION

In order to achieve the above-described objective, one aspect of a robot according to the present disclosure includes one or more processors to:

acquire external information by a sensor;

acquire an internal state of a robot body;

set, as a pseudo-emotion of the robot, a third emotion, the third emotion being determined based on a first emotion or a first degree of emotional change determined based on the external information and a second emotion or a second degree of emotional change determined based on the internal state; and

control operation of the robot, based on the set pseudo-emotion.

### BRIEF DESCRIPTION OF DRAWINGS

A more complete understanding of this application can be obtained when the following detailed description is considered in conjunction with the following drawings, in which:

FIG. 1 is a diagram illustrating an external appearance of a robot according to an embodiment;

FIG. 2 is a block diagram illustrating a functional configuration of the robot according to the embodiment;

FIG. 3 is a diagram illustrating an example in which an emotion "happy" is expressed by eyes of the robot according to the embodiment;

FIG. 4 is a diagram illustrating an example in which an emotion "subdued happy" is expressed by the eyes of the robot according to the embodiment;

FIG. 5 is a diagram illustrating an example in which an emotion "expressionless" is expressed by the eyes of the robot according to the embodiment;

FIG. 6 is a diagram illustrating an example in which an emotion "sadness (blue)" is expressed by the eyes of the robot according to the embodiment;

FIG. 7 is a diagram illustrating an example in which an emotion "sadness" is expressed by the eyes of the robot according to the embodiment;

FIG. 8 is a diagram illustrating an example in which an emotion "sadness (disgust)" is expressed by the eyes of the robot according to the embodiment;

FIG. 9 is a diagram illustrating an example in which an emotion "sadness (fear)" is expressed by the eyes of the robot according to the embodiment;

FIG. 10 is a diagram illustrating an example in which an emotion "subdued anxiety" is expressed by the eyes of the robot according to the embodiment;

FIG. 11 is a diagram illustrating an example in which an emotion "anxiety" is expressed by the eyes of the robot according to the embodiment;

FIG. 12 is a flowchart illustrating a flow of emotional expression processing of the robot according to the embodiment; and

FIG. 13 is a diagram illustrating an example of an emotion table that the robot according to an embodiment stores.

### DETAILED DESCRIPTION OF THE INVENTION

An embodiment of the present disclosure is described below with reference to the drawings. Note that the same or corresponding parts in the drawings are designated by the same reference numerals.

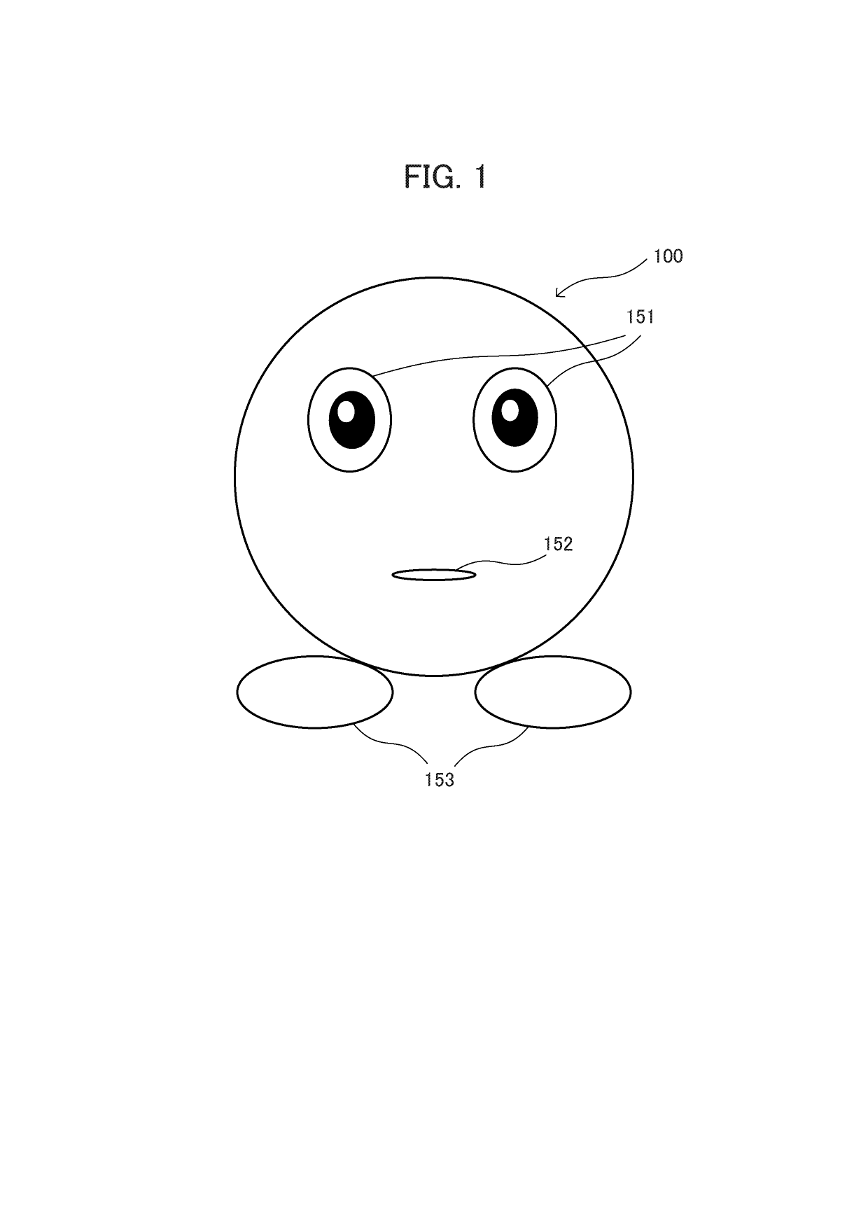

A robot 100 according to the embodiment is, as illustrated in FIG. 1, a pet robot that has a cute shape, and changes a pseudo-emotion according to a surrounding situation or the like detected by various types of sensors and expresses the pseudo-emotion to a user by facial expression (for example, expresses the pseudo-emotion by changing a design of eyes 151 or a mouth 152), body motion (for example, expresses the pseudo-emotion by moving feet 153), or the like.

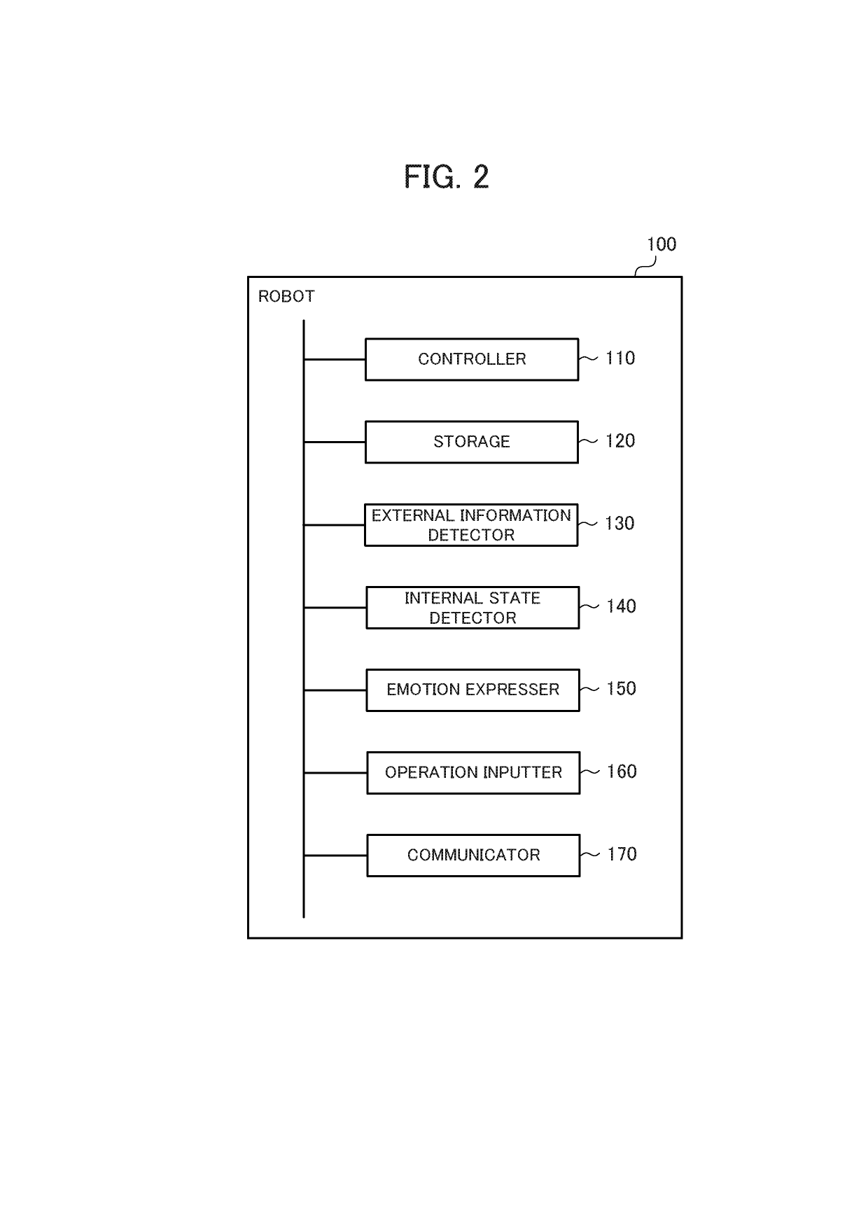

The robot 100 includes, as a functional configuration, a processor 110, a storage 120, an external information detector 130, an internal state detector 140, an emotion expresser 150, an operation inputter 160, and a communicator 170, as illustrated in FIG. 2.

The processor 110 includes, for example, a central processing unit (CPU), and executes emotional expression processing, which is described later, and the like by a program stored in the storage 120. Note that the processor 110 is compatible with multithreading functionality in which a plurality of processes is executed in parallel, and can execute various types of processing (for example, the emotional expression processing and other processing required for operation of the robot 100) in parallel. In addition, the processor 110 has a clock function and a timer function and can count date and time or the like. Note that the above-described processor may include a single CPU to perform processing alone or include two or more CPUs to perform processing in collaboration with one another.

The storage 120 includes a read only memory (ROM), a flash memory, a random access memory (RAM), and the like. In the ROM, a program that the CPU of the processor 110 executes and data that is required in advance to execute the program are stored. The flash memory is a writable non-volatile memory and stores data that needs to be saved even after power is turned off. In the RAM, data that are generated or modified while the program is executed are stored. The storage 120 also stores, for example, an expression of the eyes 151 and a motion of the feet 153 that correspond to each emotion.

The external information detector 130 includes various types of sensors and detects external information of the robot 100. Specifically, the external information detector 130 includes, for example, a tactile sensor to detect rubbing or patting, a temperature sensor to detect temperature, an image sensor to acquire an image, a microphone to acquire a sound, an illuminance sensor to detect illuminance, an acceleration sensor to detect acceleration, a gyro sensor to detect angular speed and the like, and a clock to acquire time, as the various types of sensors. The processor 110 acquires sensor information (external information) that the various types of sensors included in the external information detector 130 detect. Because of this configuration, it becomes possible to set a variety of emotions, based on various external information. Note that the external information detector 130 may include a sensor other than the above-described various types of sensors. Increasing types of sensors that the external information detector 130 include enables types of external information that the processor 110 can acquire to be increased. In addition, information that is transmitted from another device via the communicator 170 may also be treated as external information.

The internal state detector 140 includes a battery remaining amount detection device, a self-diagnosis circuit, and the like, and detects an internal state including determination information about a battery remaining amount, whether or not a battery is being charged, occurrence or non-occurrence of an error in communication or the like, occurrence or non-occurrence of a malfunction of the memory, occurrence or non-occurrence of a malfunction of the various types of sensors, and the like in the robot 100. The internal state detector 140, for example, determines, when no response has been returned from the other side of communication or when an error is detected in communication data, that a communication error has occurred, and detects an internal state including determination information indicating that there is a communication error. In addition, the internal state detector 140 executes, for example, a memory check program (a program to write data for test at an address of a memory area to be used and subsequently check whether or not the data for test can be read in from the address) and, when an error (a written value and a read-in value are different from each other) is detected, determines that the memory has a malfunction and detects an internal state including determination information indicating that a memory error has occurred. In addition, when, for example, a malfunction of a sensor is detected by the self-diagnosis circuit, the internal state detector 140 determines that the sensor has malfunctioned and detects an internal state including determination information indicating that there exists a sensor malfunction. When the determination information included in the internal state indicates that "the battery remaining amount exceeds a first threshold value (for example, 50%)", "there is no error", "there is no malfunction", and the like, the robot 100 is in a state in which there is no problem. In addition, when the determination information included in the internal state indicates that "the battery remaining amount is less than or equal to a second threshold value (for example, 20%)", "there is an error", "there is a malfunction", or the like, the robot 100 is in a state in which there is a problem.

The emotion expresser 150 includes a display that displays the eyes 151, and expresses a pseudo-emotion of the robot 100. For example, in the example illustrated in FIG. 1, a display exists inside a face of the robot 100 and openings are made in portions of the face corresponding to positions of the eyes 151, and the openings allow the eyes 151 (for example, shapes of the pupils) displayed on the display to be visually recognized by the user. Note that expressing an emotion by displaying the eyes 151 on the display of the emotion expresser 150 in this way is just an example of the emotion expresser 150, and the display of the emotion expresser 150 may, for example, express a pseudo-emotion of the robot 100 by drawing not only the eyes 151 but also the entire face. In addition, the emotion expresser 150 may include a speaker to output a cry of the robot 100 and be configured to express a pseudo-emotion of the robot 100 by uttering a cry. In addition, the emotion expresser 150 may include a motor to move the feet 153 and be configured to express a pseudo-emotion of the robot 100 by moving the feet 153. In addition, although the robot 100 illustrated in FIG. 1 does not include hands or a tail, the robot 100 may include not only the feet 153 but also other parts (the hands, the tail, and the like) and be configured to express a pseudo-emotion by moving such various parts of the body. As described above, the emotion expresser 150 can express a pseudo-emotion of the robot 100 in a manner full of a sense of a living creature, based on expression of the eyes 151, a cry, body motion, and the like.

The operation inputter 160 is an interface to accept a user operation, such as turning the power on and off and adjusting output sound volume.

The communicator 170 includes a communication module compatible with a wireless local area network (LAN) and performs data communication with an external device such as a smartphone. Examples of the data communication include reception of a remaining amount notification request and transmission of information about battery remaining amount to display the battery remaining amount of the robot 100 on the smartphone or the like,. In addition, the communicator 170 is also used when the robot 100 is connected for communication with the self-diagnosis tool and malfunction detection of the robot 100 is performed.

The functional configuration of the robot 100 is described above.

While a pseudo-emotion is an emotional expression that imitates a human emotion, for example, "Plutchik's wheel of emotions" is known as a model that represents human emotions in a general way. The emotion model includes eight basic emotions (joy, trust, fear, surprise, sadness, disgust, anger, and anticipation) and mixed emotions generated by combining two basic emotions. Continuously changing emotion is expressed by a position on an emotion map in which basic emotions that are highly related are arranged adjacent to each other in a ring shape and strength of an emotion is represented by distance from the center. The above-described emotion model is only an example, and continuous emotions may be configured to be expressed by, for example, an emotion map based on two-dimensional coordinates as described in Patent Literature 2 (Unexamined Japanese Patent Application Publication No. 2024-82536).

When an emotion represented by a position on an emotion map as described above is to be set based on a plurality of emotion setting factors such as external information and an internal state, a new emotion corresponding to an intermediate position between a position on the emotion map determined based on an emotion setting factor and a position on the emotion map determined based on another emotion setting factor may be set. Alternatively, a new emotion may be set by changing a position on the emotion map determined based on an emotion setting factor by a distance and in a direction corresponding to a degree of change in an emotion determined based on another emotion setting factor. Further alternatively, a new emotion may be set by changing a current emotion by a distance and in a direction corresponding to a degree of change in an emotion determined based on an emotion setting factor and also changing the current emotion by a distance and in a direction corresponding to a degree of change in an emotion determined based on another emotion setting factor. By the configuration as described above, it is possible to change an emotion set based on a plurality of emotion setting factors, such as external information and an internal state, to a more living creature-like emotion. Note that the degree of change in an emotion is also referred to as a degree of emotional change.

Note that although emotion setting processing as described above may be configured to determine an emotion, based on the above-described emotion map each time, the emotion setting processing may also be performed by referring to an emotion table in which emotions determined based on the emotion map are stored in advance with respect to combinations of external information and an internal state.

In addition, when a degree of priority of one emotion setting factor is different from that of another emotion setting factor, a new emotion corresponding to a position of a dividing point (internally dividing point) based on the degrees of priority on a line linking a position on the emotion map determined based on the one emotion setting factor and a position on the emotion map determined based on the another emotion setting factor may be configured to be set. In addition, the degree of change in an emotion may be configured to be increased or decreased according to the degree of priority.

The robot 100 changes a pseudo-emotion, based on the external information detected by the external information detector 130. Although how the robot 100 changes a pseudo-emotion is arbitrarily determined, the processor 110 can change the pseudo-emotion, based on external stimulus (which is detectable by the external information detector 130), as described in, for example, Patent Literature 2. On this occasion, the processor 110 may determine a degree of change in an emotion, based on the external stimulus and change the emotion, using the degree of change in the emotion determined based on the external stimulus.

In addition, the robot 100 changes a pseudo-emotion, based on not only the external information but also the internal state such as a battery remaining amount, an error, and a malfunction. For example, when the battery remaining amount becomes small, the pseudo-emotion changes to sadness. In a similar manner to the external information, the processor 110 may determine a degree of change in an emotion, based on the internal state and change the emotion, using the degree of change in the emotion determined based on the internal state.

When there is an inconsistency between emotional change based on the external information and emotional change based on the internal state, the processor 110 of the robot 100 mediates the emotional changes and expresses an appropriate emotion. For example, when there is no problem in the internal state, the processor 110 basically expresses an emotion based on the external information. However, when a problem occurs in the internal state, the processor 110 increases the degree of priority of the emotion based on the internal state according to the degree of risk in the internal state. For example, when, as the internal state, the battery remaining amount exceeds 50% and there are no other error or malfunction, emotional change based on the internal state is not used, and only emotional change based on the external information is used. Conversely, when a risk that may render the robot 100 inoperable, such as the battery remaining amount falling below 5% and a malfunction of the memory being detected, is detected, emotional change based on the external information is not used, and only emotional change based on the internal state is used. Because of this configuration, the robot is, at normal times (when there is no problem in the internal state), capable of expressing an emotion full of a sense of a living creature, based on the external information, and, at the time of emergency (when a problem has occurred in the internal state), also capable of informing the user that an abnormal situation has occurred in the robot 100 without losing a sense of a living creature, based on the internal state.

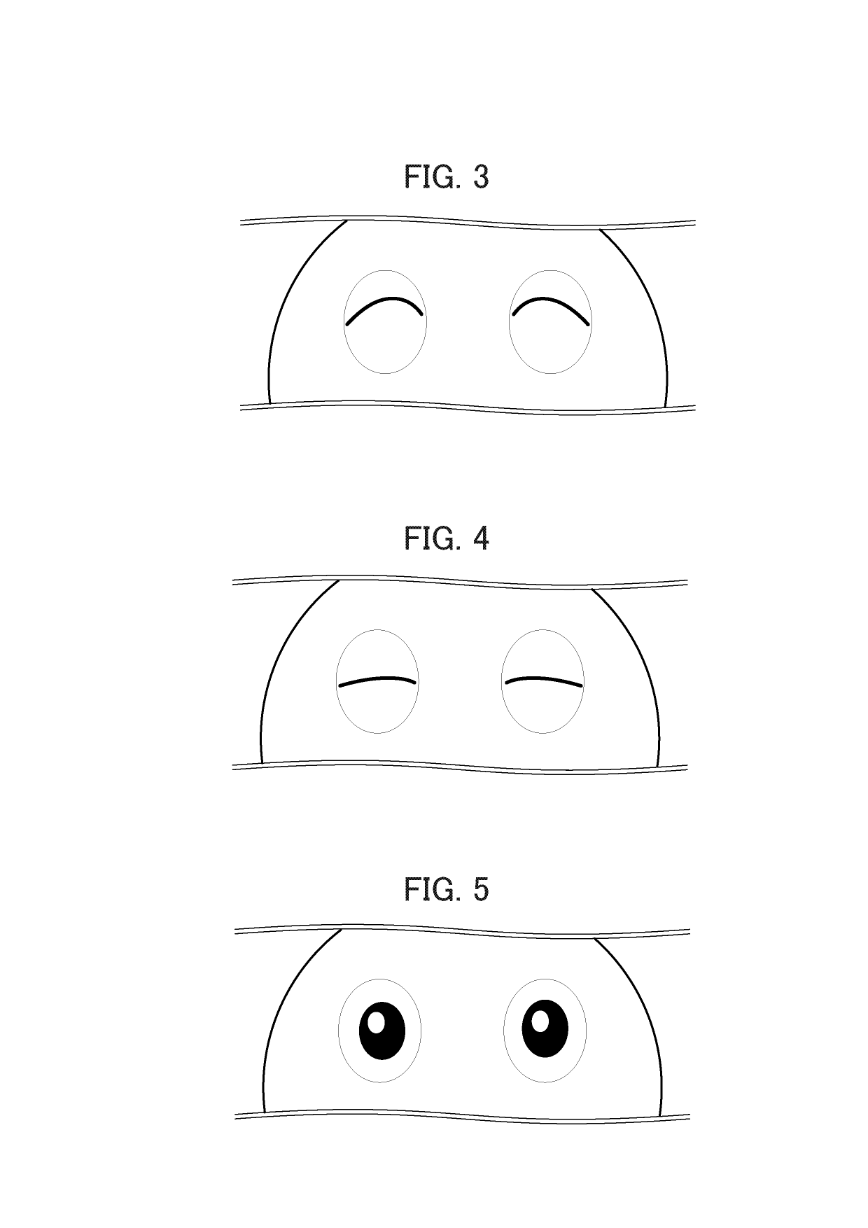

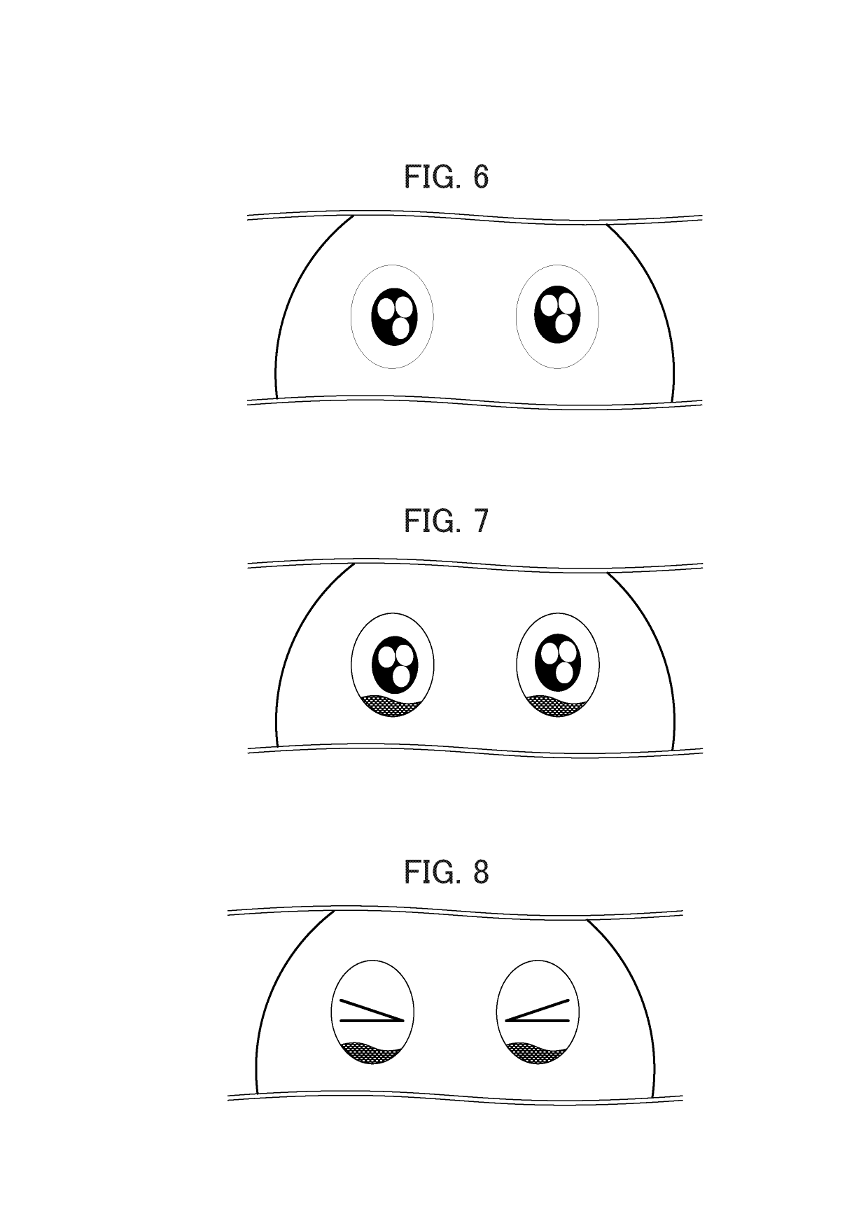

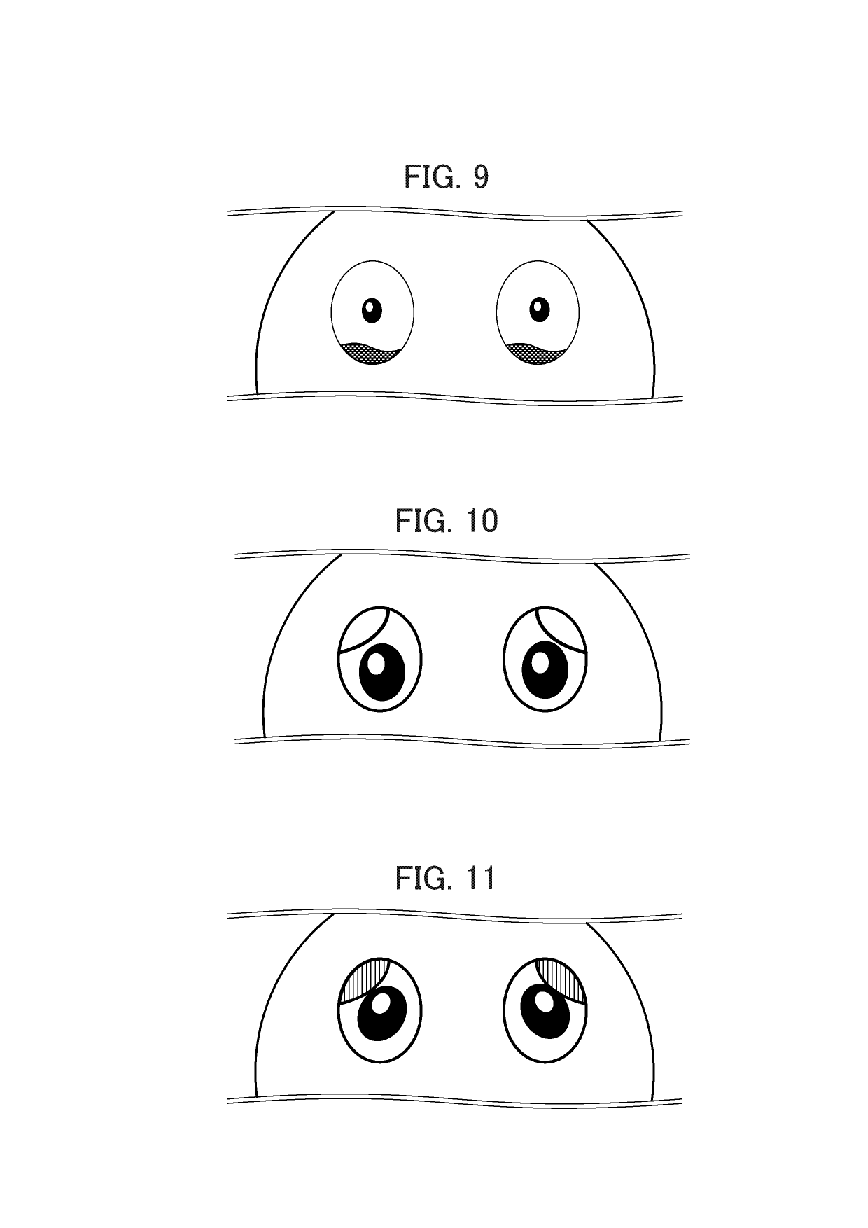

The robot 100 changes a design of the eyes 151 (shapes and sizes of the eyes 151, shapes, brightness, sizes, and positions of the pupils, presence or absence of tears, existence or nonexistence of eyelashes, a state of eyelids, and the like) by the emotion expresser 150 to express a pseudo-emotion. Although how the design of the eyes 151 is changed according to a pseudo-emotion can be arbitrarily determined, examples are illustrated in FIGS. 3 to 12. Although, in the examples, each of the nine types of pseudo-emotions is expressed by changing the design of the eyes 151, the method for expressing the pseudo-emotions is not limited thereto. For example, in place of changing the design of the eyes 151 or in addition to changing the design of the eyes 151, a design of the mouth 152 (such as a shape, size, and a position of the mouth 152) may be changed. In addition, emotions may be expressed not only by changing the facial expressions but also by a type of cry output from the speaker or by moving other parts (for example, the feet 153) of the robot 100.

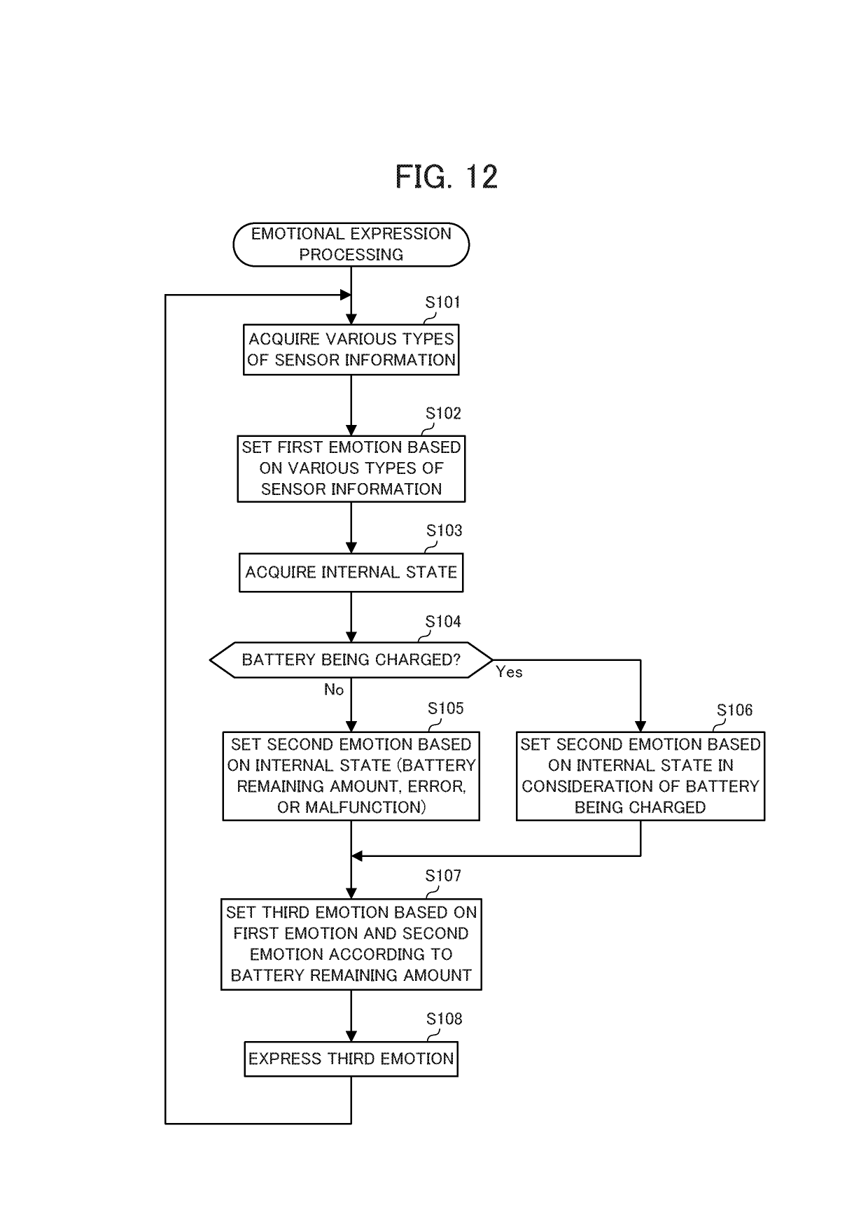

Next, with reference to a flowchart illustrated in FIG. 12, the emotional expression processing executed by the processor 110 of the robot 100 is described. The emotional expression processing is processing of the robot 100 setting a pseudo-emotion of the robot 100, based on the external information (sensor information) from the external information detector 130 and the internal state (determination information relating to the battery remaining amount, an error, and a malfunction) from the internal state detector 140. When the user turns on the power of the robot 100, the emotional expression processing is started.

First, the processor 110 acquires various types of sensor information that the various types of sensors included in the external information detector 130 detect (step S101). Next, the processor 110 sets a first emotion, based on the acquired various types of sensor information (step S102). For example, when the tactile sensor detects that a head of the robot 100 is being rubbed by the user, the processor 110 sets an emotion "happy" as the first emotion (an emotion determined based on the external information). Note that as described above, when setting the first emotion, the processor 110 may determine a first degree of emotional change, based on the acquired various types of sensor information and set the first emotion, based on the determined first degree of emotional change.

Next, the processor 110 acquires an internal state detected by the internal state detector 140 (step S103). Next, the processor 110 determines, based on information about whether or not the battery is being charged in the acquired internal state, whether or not the battery is being charged (step S104).

When the battery is not being charged (step S104; No), the processor 110 sets a second emotion, based on the acquired internal state (step S105). For example, when the processor 110 acquires, as the internal state, the battery remaining amount being 50% or less, the processor 110 sets an emotion "sad" as the second emotion (an emotion determined based on the internal state) (the processor 110 may set one of different levels of emotion "sad", such as "sadness (blue)", "sadness", "sadness (disgust)", "sadness (fear)", and the like), depending on the battery remaining amount). Subsequently, the processor 110 proceeds to step S107.

When the battery is being charged (step S104; Yes), the processor 110 sets, based on the acquired internal state, the second emotion in consideration of the battery being charged (step S106). For example, the processor 110 sets, for a predetermined time (for example, 2 seconds) after charging of the battery is started, the emotion "happy" as the second emotion, and subsequently sets an emotion based on the battery remaining amount (for example, sets, when the battery remaining amount exceeds 50%, "happy" and, when 50% or less, "sad", and the like). Subsequently, the processor 110 proceeds to step S107.

Note that in steps S105 and S106, when setting the second emotion, the processor 110 may determine a second degree of emotional change, based on the acquired internal state and set a second emotion, based on the determined second degree of emotional change.

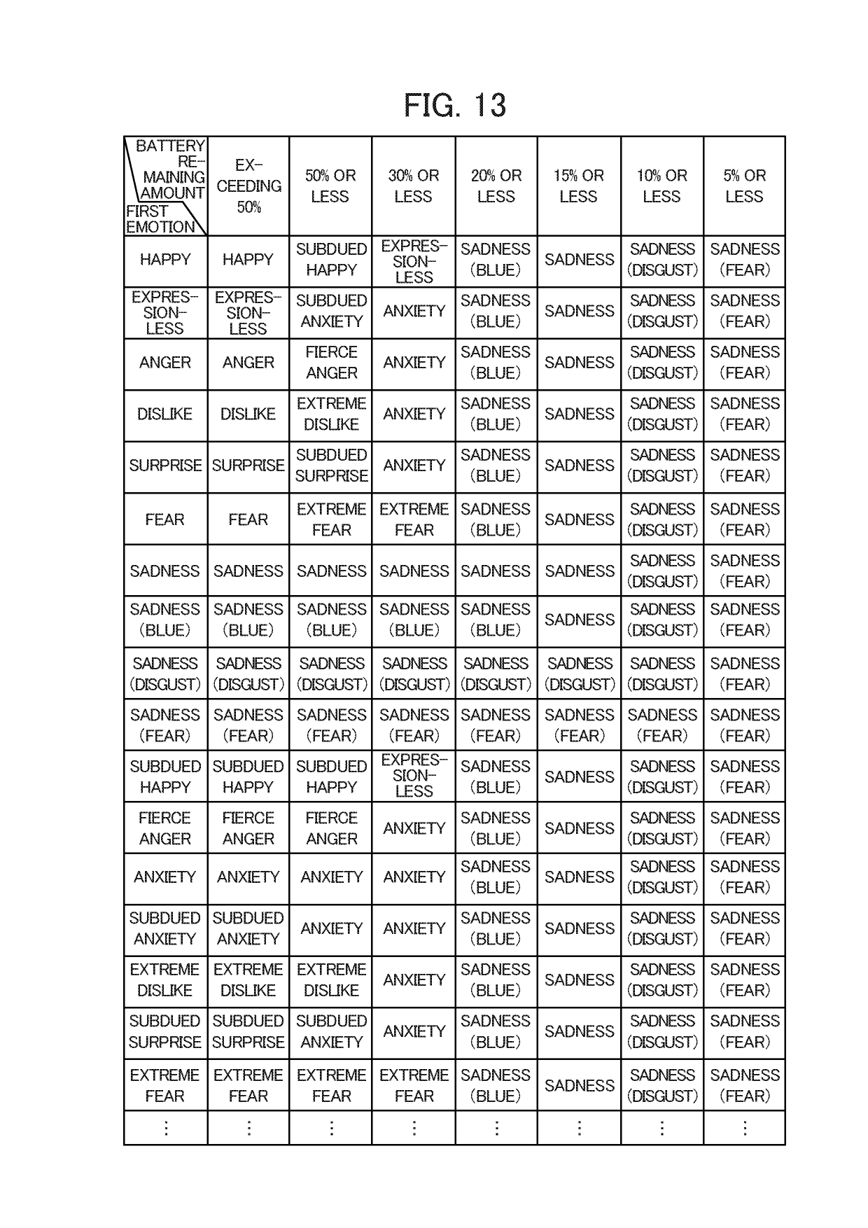

In step S107, the processor 110 sets, based on the set first and second emotions, a third emotion according to the battery remaining amount. For example, when the internal state is a first state (for example, a state in which the battery remaining amount exceeds the first threshold value (for example, 50%)), the processor 110 neglects the second emotion and sets the first emotion as the third emotion. In addition, when the internal state is a second state (for example, a state in which the battery remaining amount is less than or equal to the second threshold value (for example, 20%)), the processor 110 neglects the first emotion and sets the second emotion as the third emotion. In addition, when the internal state is a third state (for example, the battery remaining amount is less than or equal to the first threshold value and greater than the second threshold value), the processor 110 determines, based on the internal state (for example, the battery remaining amount), the degrees of priority of the external information and the internal state and sets the third emotion in accordance with the external information (first emotion), the internal state (second emotion), and the determined degrees of priority. For example, the processor 110 sets an emotion obtained by combining the first emotion and the second emotion at a ratio corresponding to the battery remaining amount as the third emotion. Although a method for combining emotions at a ratio corresponding to the battery remaining amount can be arbitrarily determined, the processor 110 may, for example, combine the first emotion and the second emotion at a ratio corresponding to the battery remaining amount by setting the third emotion, based on an emotion table as illustrated in FIG. 13. In the emotion table illustrated in FIG. 13, third emotions that are set based on the first emotion and the battery remaining amount when there is neither error nor malfunction and neither is the battery being charged according to the internal state detected by the internal state detector 140 are defined. Note that when setting the third emotion in step S107, the processor 110 may use the first degree of emotional change in place of the first emotion and may use the second degree of emotional change in place of the second emotion. That is, in step S107, the processor 110 may set the third emotion, based on the first emotion or the first degree of emotional change, which is determined based on the external information, and the second emotion or the second degree of emotional change, which is determined based on the internal state.

Next, the processor 110 controls the emotion expresser 150 to express the third emotion (step S108). For example, when the third emotion is "happy", the processor 110 controls the emotion expresser 150 to display the eyes 151 as illustrated in FIG. 3. Subsequently, the processor 110 returns to step S101.

Since through the above-described emotional expression processing, the robot 100 sets a pseudo-emotion, based on an emotion based on the external information and an emotion based on the internal state, the robot 100 can express a more living creature-like emotion.

In the robot device disclosed in Unexamined Japanese Patent Application Publication No. 2002-233977, a mechanism in which appetite and emotion influence each other, such as the robot device easily becoming angry when hungry, is introduced. However, in such a prior art, although it is possible to make it easier for the robot device to have an emotion "angry" when the battery remaining amount is reduced, combining an emotion based on information input from the outside with an emotion based on the battery remaining amount is not taken into consideration, and there have been some cases where expression of a living creature-like emotion is impaired. The present disclosure solves the above-described problem of the prior art, and according to the present disclosure, it is possible to express a more living creature-like emotion.

In addition, since the processor 110 determines the degrees of priority of the external information and the internal state, based on the internal state and sets a pseudo-emotion of the robot 100 in accordance with the external information, the internal state, and the determined degrees of priority, when, for example, the robot 100 is determined to be in a risky state, based on the internal state, the robot 100 can express an emotion notifying the risk by raising the degree of priority of the internal state to notify the degree of risk and thus notify the user that the robot 100 is in a risky state without losing a sense of a living creature.

In addition, since the processor 110 sets a pseudo-emotion of the robot 100 using the external information when the internal state is the first state (a state in which none of the pieces of determination information indicates a problem) and sets a pseudo-emotion of the robot 100 using the internal state when the internal state is the second state (a state in which at least one of the pieces of determination information indicates a problem), when the internal state is safe (first state) or risky (second state), the first emotion based on the external information or the second emotion based on the internal state can be directly used as the third emotion, which enables the processing to be more efficient.

In addition, since when the internal state of the robot 100 is a third state that is neither the first state nor the second state (for example, a state in which determination of whether there is a problem or not cannot be made from the determination information), the processor 110 sets a pseudo-emotion of the robot 100, using both the external information and the internal state, the processor 110 is capable of setting an appropriate emotion, based on a greater amount of information.

Note that when the internal state acquired in step S103 includes a critical malfunction (for example, a malfunction that may cause the robot 100 not to be activated, such as a memory malfunction), the processor 110 may set an emotion that makes the robot 100 look as if dying (for example, rolling the eyes back) as the third emotion and proceed to step S108 without proceeding to step S104. In this case, the first emotion based on the external information is to be neglected. By expressing that the robot 100 is in a state of being on the verge of dying in this way, it is possible to notify the user that the robot 100 is currently in a highly risky state without losing a sense of a living creature.

In addition, when a malfunction of another type that is not considered critical (for example, an abnormality of the tactile sensor) is detected by the internal state detector 140, the processor 110 may further modify, after step S107, the third emotion, based on the malfunction. For example, when an abnormality of the tactile sensor is detected (even when the third emotion is set to an emotion other than "anxiety" (for example, "happy") in step S107), the processor 110 may set (modify or change) the third emotion to "anxiety". In addition, on this occasion, when the degree of risk of the battery remaining amount is higher than the degrees of risk of the malfunction of another type (for example, the degree of risk of the battery remaining amount being 15% or less is higher than the degree of risk of an abnormality of the tactile sensor), the processor 110 may be configured to use the third emotion set in step S107 as it is without modifying (changing) the third emotion. By performing processing in this way, the robot 100 is capable of preferentially expressing an emotion that notifies a state with a higher degree of risk.

In addition, in the emotional expression processing, the processor 110 may determine change in the internal state and control the operation of the robot 100 according to a result of the determination. For example, when it is determined that the internal state has not changed from the first state, the processor 110 may control the operation of the robot 100, based on the third emotion (in which the first emotion is set, that is, that is determined based on the external information), and when it is determined that the internal state has changed from the first state to the second state, the processor 110 may change the third emotion from the (first) emotion determined based on the external information to the (second) emotion determined based on the internal state and control the operation of the robot 100, based on the changed third emotion (in which the (second) emotion determined based on the internal state is set).

On this occasion, when it is determined that the internal state has changed from the first state to the second state, the processor 110 may set the third emotion to an emotion that is changed from the (first) emotion, which is determined based on external information, to the (second) emotion, which is determined based on the internal state, in a direction of change or by a change amount matching the second state. As a result, it is possible to, for example, set an emotion obtained by combining the (first) emotion, which is determined based on the external information, and the (second) emotion, which is determined based on the internal state, at a ratio corresponding to the battery remaining amount, as the third emotion.

In addition, when it is likewise determined that the internal state has changed from the first state to the second state, the processor 110 may set the third emotion by suppressing change in the emotion to a (first) emotion that is determined based on the external information. For example, although when the robot 100 is spoken to by the user, generally (in a case where the battery remaining amount is high), the (first) emotion, which is determined based on the external information, changes from "sad" to "happy", in a case where the battery remaining amount is low, the processor 110, by performing control as described above, sets the third emotion by suppressing change in the emotion in such a way that even when the user speaks to the robot 100, the (first) emotion, which is determined based on the external information, does not change from "sad" to "happy", but to as far as, for example, an emotion "expressionless".

By performing processing in this way, the robot 100 can express a fine difference between emotions that cannot be expressed only by the first emotion, which is determined simply based on the external information, or the second emotion, which is determined simply based on the internal state.

In addition, the processor 110 may set priorities for external information and internal states (such as the battery remaining amount, an error, and a malfunction) and set the third emotion based on the priorities.

For example, when the internal state includes determination information relating to the battery remaining amount and an error, although the processor 110 may use, when no error has occurred, the third emotion that is set based on the first emotion based on the external information and the second emotion based on the battery remaining amount, as it is, the processor 110 may, when an error has occurred, change the third emotion, which is set based on the first emotion based on the external information and the second emotion based on the battery remaining amount, according to details of the error having occurred.

In addition, when the internal state includes determination information relating to the battery remaining amount, an error, and a malfunction, although the processor 110 may use, when no malfunction has occurred, the third emotion that is set based on the first emotion based on the external information and the second emotion based on the battery remaining amount and an error, as it is, the processor 110 may, when a malfunction has occurred, change the third emotion, which is set based on the first emotion based on the external information and the second emotion based on the battery remaining amount and an error, according to details of the malfunction having occurred.

In general, a state in which an error has occurred has a higher degree of risk than a state in which the battery remaining amount is low, and a state in which a malfunction has occurred has a higher degree of risk than the state in which an error has occurred. Therefore, by performing processing in this way, the robot 100 is capable of notifying, when the robot 100 is brought into a state of a high degree of risk, the user of the state of the robot 100 without losing a sense of a living creature.

In addition, although in the above-described embodiment, the description is made under the assumption that the processor 110 sets the first emotion, based on the external information, sets the second emotion, based on the internal state, and sets the third emotion, based on both the first and second emotions, the processor 110 does not have to set an emotion in such a process as long as it is possible to eventually set an emotion to be expressed by the emotion expresser 150. For example, the processor 110 may be configured to express, by the emotion expresser 150, an emotion that is set based on the first emotion and the internal state without performing the processing of setting the second emotion. In addition, the processor 110 may be configured to express, by the emotion expresser 150, an emotion that is set based on the external information and the internal state without performing the processing of setting the first emotion and the processing of setting the second emotion. For example, it may be configured such that a large amount of data including "external information, internal states, and pseudo-emotions determined based on the external information and internal states" are prepared in advance as learning data and a deep neural network is trained using the learning data, and the processor 110 expresses, by the emotion expresser 150, a pseudo-emotion that is output when external information and an internal state are input into the deep neural network.

By performing processing in this way, the processor 110 is capable of setting the third emotion while omitting the processing of setting the first and second emotions, and performing more efficient emotion setting.

Note that the present disclosure is not limited to the above-described embodiment and various modifications and applications are possible. For example, although in the above-described embodiment, the processor 110 of the robot 100 is configured to set a pseudo-emotion, a device separate from the robot 100 (a device controlling the robot 100) may include a processor to control a pseudo-emotion of the robot 100 and a communicator and be configured to control the emotion expresser 150 included in the robot 100 via the communicator 170 included in the robot 100.

In the above-described embodiment, the description is made under the assumption that an operation program that the CPU of the processor 110 executes is stored in the ROM or the like of the storage 120 in advance. However, the present disclosure is not limited to the configuration, and by implementing an operation program to execute the above-described various types of processing into an existing general-purpose computer or the like, the computer may be made to function as a device to control the robot 100 according to the above-described embodiment.

An arbitrary method can be employed as a providing method of such a program, and, for example, the program may be stored in and distributed by a non-transitory computer-readable recording medium (such as a flexible disk, a compact disc (CD)-ROM, a digital versatile disc (DVD)-ROM, a magneto-optical disc (MO), a memory card, and a USB memory) or may be provided by storing the program in a storage on a network, such as the Internet, and causing a user to download the program.

In addition, when the above-described processing are to be executed through sharing of processing between an operating system (OS) and an application program or collaboration between the OS and the application program, only the application program may be stored in a non-transitory recording medium or a storage. In addition, it is also possible to superimpose a program on a carrier wave and distribute the program via a network. For example, the above-described program may be posted on a bulletin board system (BBS) on the network, and the program may be distributed via the network. The above-described processing may be configured to be able to be performed by starting up and executing the distributed program in a similar manner to other application programs under the control of the OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A robot, comprising
one or more processors to:
acquire external information by a sensor;
acquire an internal state of a robot body;
set, as a pseudo-emotion of the robot, a third emotion, the third emotion being determined based on a first emotion or a first degree of emotional change determined based on the external information and a second emotion or a second degree of emotional change determined based on the internal state; and
control operation of the robot, based on the set pseudo-emotion.

2. The robot according to claim 1, wherein
the one or more processors
determine degrees of priority of the external information and the internal state, based on the internal state and set the pseudo-emotion of the robot in accordance with the external information, the internal state, and the determined degrees of priority.

3. The robot according to claim 2, wherein
the one or more processors
set, in a case where the internal state is determined to be a first state, the pseudo-emotion of the robot, using the external information, and
set, in a case where the internal state is determined to be a second state, the pseudo-emotion of the robot, using the internal state.

4. The robot according to claim 3, wherein
the one or more processors
set, in a case where the internal state is determined to be a first state, the pseudo-emotion of the robot, using the external information,
set, in a case where the internal state is determined to be a second state, the pseudo-emotion of the robot, using the internal state, and
set, in a case where the internal state is determined to be a third state, the pseudo-emotion of the robot, using both the external information and the internal state.

5. The robot according to claim 3, wherein
the internal state includes determination information relating to at least one of a battery remaining amount, an error, and a malfunction,
the first state is a state in which none of pieces of determination information included in the internal state indicates a problem, and
the second state is a state in which at least one of pieces of determination information included in the internal state indicates a problem.

6. The robot according to claim 5, wherein
the one or more processors
set priorities for the external information, the battery remaining amount, the error, and the malfunction and set the third emotion, based on the priorities.

7. The robot according to claim 5, wherein
the one or more processors:
determine whether or not the internal state has changed from the first state to the second state;
control, in a case where the internal state is determined not to have changed from the first state, operation of the robot, based on the third emotion, the third emotion being determined based on the external information; and
change, in a case where the internal state is determined to have changed from the first state to the second state, the third emotion from an emotion determined based on the external information to an emotion determined based on the internal state and control operation of the robot, based on the changed third emotion.

8. The robot according to claim 7, wherein
the one or more processors
set, in a case where the internal state is determined to have changed from the first state to the second state, the third emotion that is changed from an emotion determined based on the external information to an emotion determined based on the internal state in a direction of change or by a change amount matching the second state.

9. The robot according to claim 7, wherein
the one or more processors
set, in a case where the internal state is determined to have changed from the first state to the second state, the third emotion by suppressing change in emotion to an emotion determined based on the external information.

10. The robot according to claim 7, wherein
the internal state includes determination information relating to a battery remaining amount and an error, and
the one or more processors
change, in a case of determining, based on the determination information, that the error has occurred, the third emotion, the third emotion being set based on the external information and the battery remaining amount, according to details of an error having occurred.

11. The robot according to claim 10, wherein
the internal state includes determination information relating to a battery remaining amount, an error, and a malfunction, and
the one or more processors
change, in a case of determining, based on the determination information, that the malfunction has occurred, the third emotion, the third emotion being set based on the external information, the battery remaining amount, and details of the error, according to details of a malfunction having occurred.

12. The robot according to claim 1, wherein the external information includes sensor information relating to at least one of a tactile sense, an image, temperature, sound, and illuminance, the sensor information being acquired by the sensor.

13. The robot according to claim 1, wherein
the one or more processors
control an expression of eyes of the robot or a cry of the robot in such a manner as to express the set third emotion.

14. A robot control method, comprising:
by one or more processors,
acquiring external information by a sensor;
acquiring an internal state of a robot body;
setting, as a pseudo-emotion of the robot, a third emotion, the third emotion being determined based on a first emotion or a first degree of emotional change determined based on the external information and a second emotion or a second degree of emotional change determined based on the internal state; and
controlling operation of the robot, based on the set pseudo-emotion.

15. A non-transitory computer-readable recording medium storing a program causing one or more processors to execute processing comprising;
acquiring external information by a sensor;
acquiring an internal state of a robot body;
setting, as a pseudo-emotion of the robot, a third emotion, the third emotion being determined based on a first emotion or a first degree of emotional change determined based on the external information and a second emotion or a second degree of emotional change determined based on the internal state; and
controlling operation of the robot, based on the set pseudo-emotion.
